(19) United States
(12) Patent Application Publication
(10) Pub. No.: US 2006/0076120 A1
(43) Pub. Date: Apr. 13, 2006

(54) Cooling system with pre-cleaning

(75) Inventor: Nicholas Edward Bollweg, Dubuqe, IA (US)

Correspondence Address: DEERE & COMPANY, ONE JOHN DEERE PLACE, MOLINE, IL, 61265, US

(73) Assignee: Deere & Company, a Delaware corporation

(21) Appl. No.: 10/963,247

(22) Filed: Oct. 12, 2004

(51) Int. Cl. B60H 1/00; F28F 19/00

(52) U.S. Cl. 165/41; 165/119

(57) ABSTRACT

An cooling system and method for a work vehicle in which atmospheric air is pre-cleaned prior to flowing it over a heat exchanger and then exhausted back into the surrounding atmosphere. At least one fan draws atmospheric air having particulate content into at least one pre-cleaner where the atmospheric air is pre-cleaned to produce pre-cleaned air with a reduced particulate content. The pre-cleaned air is then drawn into a chamber, flowed over or through the heat exchanger contained in the chamber, and exhausted from the chamber to the surrounding atmosphere. The fluid in the heat exchanger is cooled as the pre-cleaned air flows through or over the heat exchanger.

### FIELD OF THE INVENTION

The invention relates to cooling systems for work vehicles operating in atmospheres with relatively high particulate contents. More specifically, it relates to a system and method for pre-cleaning ambient air with a relatively high particulate content to produce pre-cleaned air with a reduced particulate content and supplying the pre-cleaned air to a heat exchanger for heat exchange purposes.

### BACKGROUND OF THE INVENTION

Heat exchangers have, traditionally, been designed to accommodate the environment in which they operate. Thus, the heat exchangers for automobiles have tended to be compact with dense fin counts where the fins tend to have louvers. This allows such heat exchangers to be designed with a much needed compactness. Blocking of the louvers is unlikely under automobiles operating conditions then as the air in the environments in which automobiles operate tends to have relatively low particulate content. However, the heat exchangers for work vehicles tend to have simple, non-louvered fins and very low fin counts to minimize a relatively high degree of plugging with dirt, debris, chaff, pine needles, etc. often contained in the surrounding air in which these vehicles tend to operate as plugging tends to block air flow through the heat exchanger and, thus, to reduce the net heat exchanged.

### SUMMARY OF THE INVENTION

As stated above, the heat exchangers for work vehicles tend to have very low counts of simple non-louvered fins in order to avoid plugging. Thus, in order to achieve equivalent heat transfer, the heat exchangers for work vehicles must be somewhat larger than automotive heat exchangers. As a result, the heat exchangers for work vehicles are substantially larger than automotive heat exchangers. However, in reality, the heat exchangers for the work vehicles often become plugged despite their larger size and greater simplicity.

Described herein is a system and method of supplying a heat exchanger with air having a low particulate content in an overall environment of air with a high particulate content. Thus, the system and method described allow for greater compactness as well as improved overall efficiency in heat exchangers for work vehicles. With such a system and method, downtime of the vehicle for cleaning, i.e., unplugging the heat exchanger, may be significantly reduced and, under some circumstances, eliminated.

### BRIEF DESCRIPTION OF THE DRAWINGS

Embodiments of the invention will be described in detail, with references to the following figures, wherein:

FIG. 1 is a side view of a work vehicle including an exemplary embodiment of the invention;

FIG. 2 is an oblique view from a left side of the rear portion of the vehicle illustrated in FIG. 1;

FIG. 3 is an oblique view from a right side of the rear portion of the vehicle illustrated in FIG. 1;

FIG. 4 is an exploded view of the cooling system illustrated in FIG. 2;

FIG. 5 is an oblique view of one of the pre-cleaners, illustrated in FIGS. 2 and 3, showing the details of an outlet; and

FIG. 6 is a side view of a conventional work vehicle.

### DESCRIPTION OF THE PREFERRED EMBODIMENT

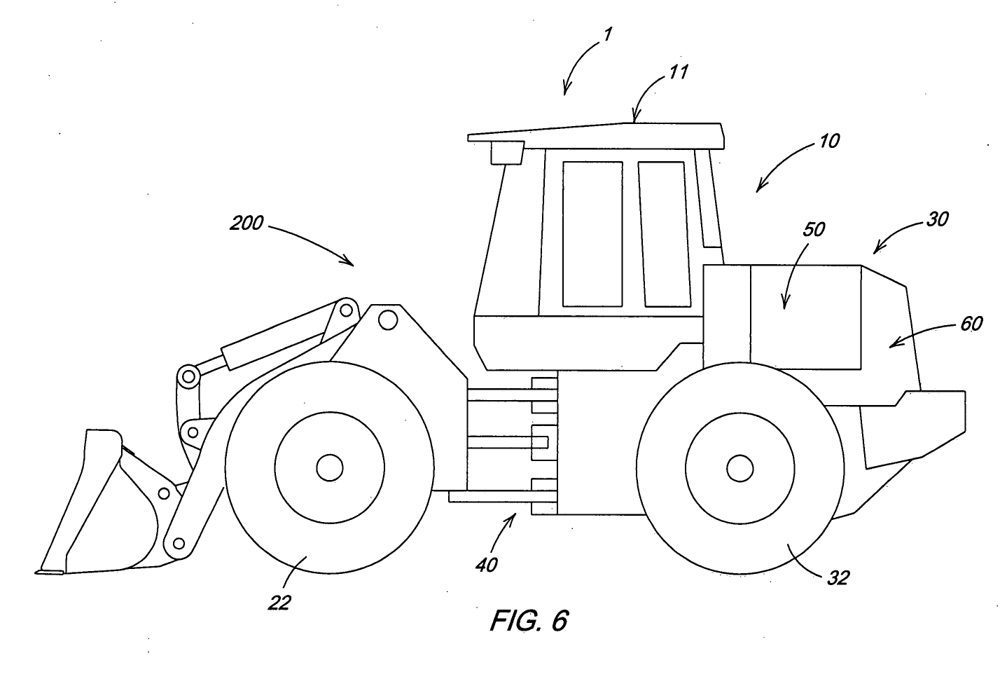

FIG. 6 illustrates a conventional work vehicle. The particular work vehicle illustrated in FIG. 6 is an articulated four wheel drive loader 1 having a body 10 that includes a front body portion 20 pivotally connected to a rear body portion 30 by vertical pivots 40, the loader being steered by pivoting of the front body portion 20 relative to the rear body portion 30 in a manner well known in the art. The rear body portion 30 includes an engine compartment 50 and a cooling area 60. The front and rear body portions 20 and 30 are respectively supported on front drive wheels 22 and rear drive wheels 32. An operator's station 11 is provided on the rear body portion 30 and is generally located above the vertical pivots 40. The front and rear drive wheels 22 and 32 propel the vehicle along the ground and are powered in a manner well known in the art.

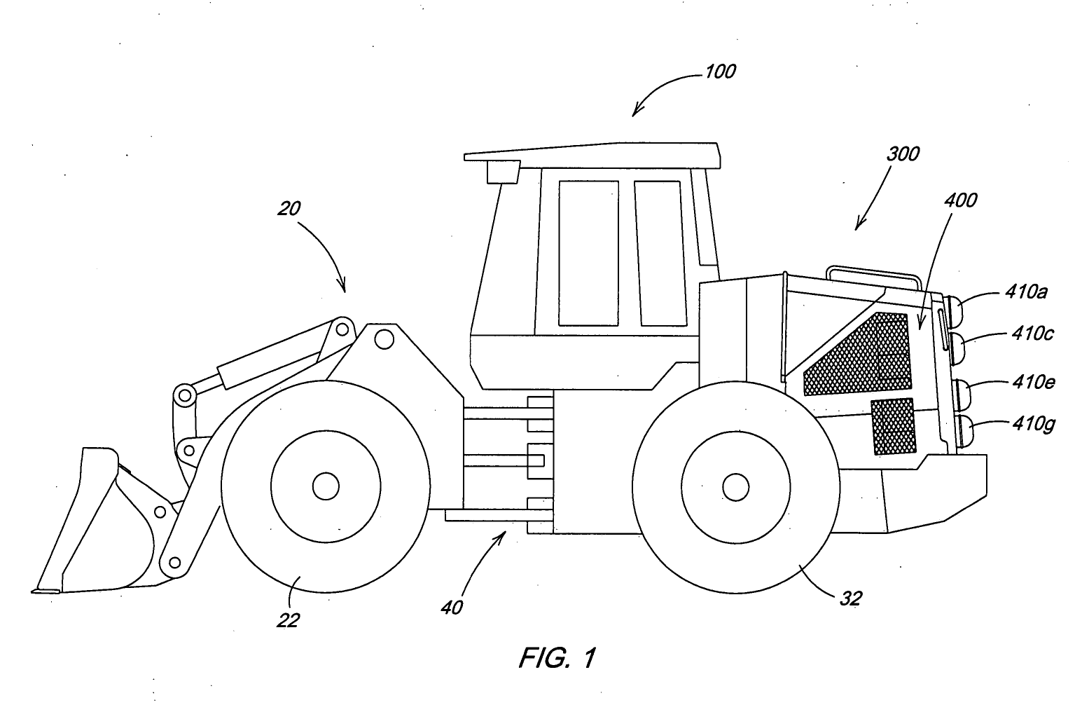

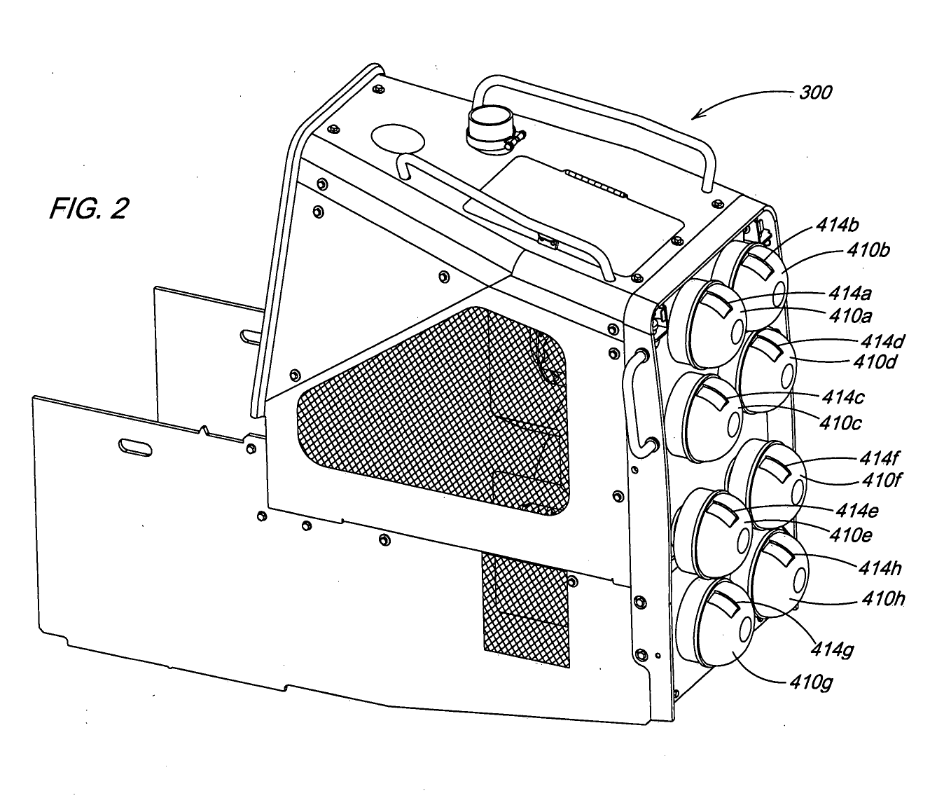

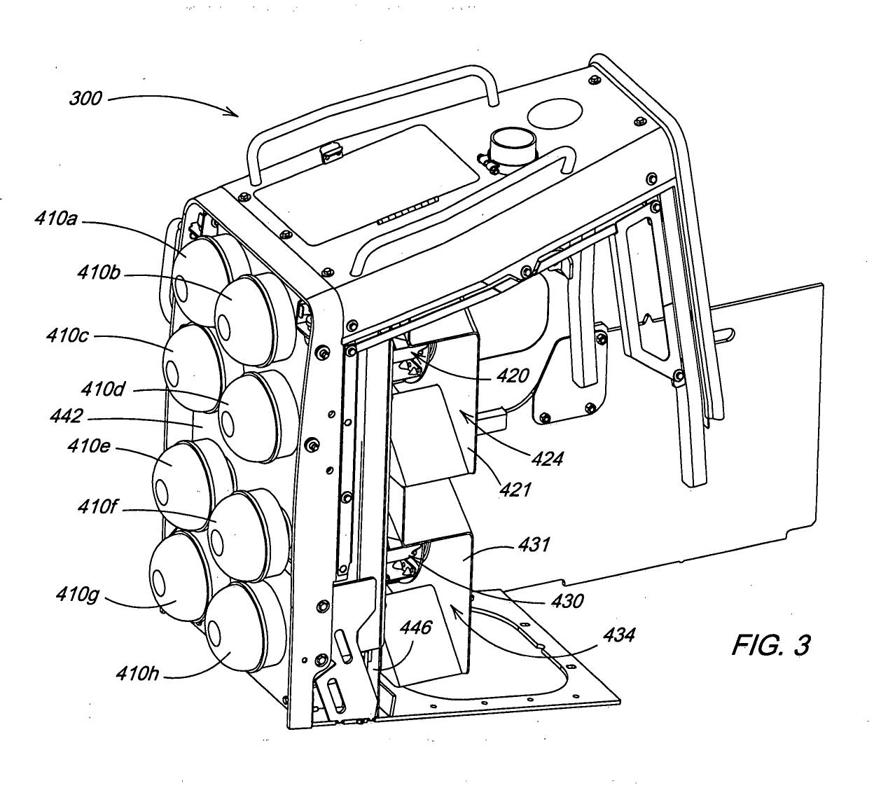

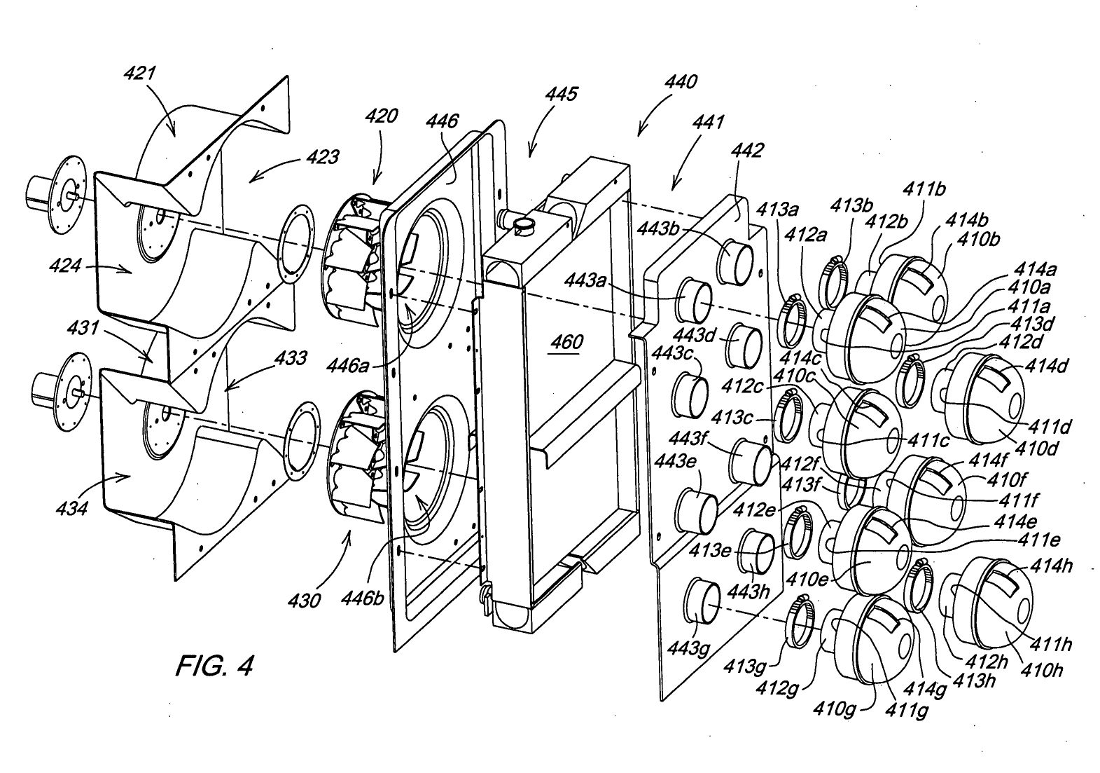

FIG. 1 is a side view of a loader 100 illustrating a rear body portion 300 including an exemplary embodiment of the cooling system 400 of the invention. FIGS. 2-4 are detailed views of the cooling system 400 of FIG. 1. The loader 100 of FIG. 1 is substantially identical to the loader 1 of FIG. 6 excepting the rear body portion 300 containing the cooling system 400.

As illustrated in FIGS. 1-4, the cooling system 400 includes: eight pre-cleaners 410a-410h; two backward curved centrifugal fans 420, 430; two integrated fan housings 421, 431 acting as partial enclosures for fans 420, 430, respectively; a first wall for 442; a second wall for 446; and a heat exchanger 460.

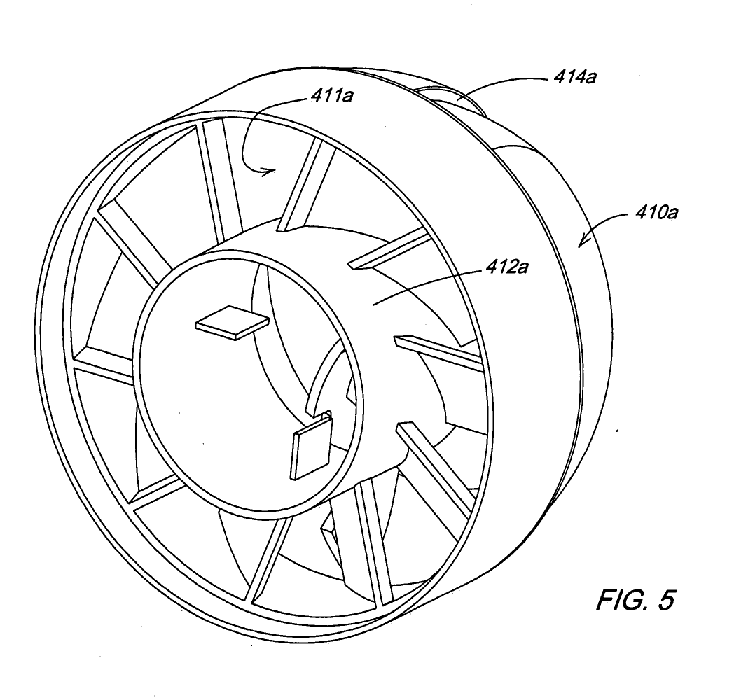

The pre-cleaners 410a-410h may be conventional and could include any of a number of pre-cleaners currently available on the market or they may be fabricated by anyone skilled in the art. The pre-cleaners have inlets 411a-411h and outlets 412a-412h, respectively. They are passive in this particular embodiment but may be powered. FIG. 5 is an oblique view of pre-cleaner 410a which is representative of pre-cleaners 410b-410h. The fans 420, 430 of this particular embodiment are hydraulically driven. However, they may be electrically or mechanically driven.

A chamber 440 isolates the heat exchanger 460 and comprises a first portion 441 and a second portion 445. The first portion 441 includes the first wall 442 containing eight holes 442a-442h with eight mating integrated cylinders 443a-443h and the heat exchanger 460. The second portion 445 includes the second wall 446 containing two holes 446a, 446b and the heat exchanger 460. Every joined portion of the chamber 440 is joined via nuts and bolts and sealed with caulking or rubber (not shown).

The pre-cleaners 410a-410h are attached to the first portion by slipping the pre-cleaner outlets 412a-412h over the mating integrated cylinders 443a-443h and holding them in place via friction with the help of tightened hose clamps 413a-413h. The tightened hose clamps 413a-413h also serve to provide a seal that allows only pre-cleaned air to enter the chamber 440.

The integrated fan housings 421, 431 of this embodiment are attached, via nuts and bolts (not shown), to the second wall 446 to form fan inlets 422 and 432 at each of the holes 446a and 446b respectively. Airtight seals of caulking or rubber (not shown) are formed between the second wall 446 and the fan housings 421, 431 along the periphery of the fan housings 421, 431.

In operation, the fans 420, 430 draw atmospheric air having particulate content into the pre-cleaners 410a-410h, via the pre-cleaner inlets 411a-411h, where pre-cleaned air is produced via a mechanical action of the pre-cleaners 410a-410h, separating a portion of the particulate content from the atmospheric air to produce the pre-cleaned air. In this particular embodiment of the invention, the mechanical action of the pre-cleaners 410a-410h is generated by the movement of the atmospheric air over mechanical components of the pre-cleaners 410a-410h. The pre-cleaned air is then drawn from the pre-cleaner outlets 412a-412h and into the chamber 440 via the holes 442a-442h in the first wall 442. The fans 420, 430 then draw the pre-cleaned air: through or over the heat exchanger 460 where a cooling of fluid in the heat exchanger 460 occurs; out of the chamber via the holes 446a, 446b in the second wall 446; and into the fan housings 421, 431 via the fan inlets 422, 432. Finally, the fans 420, 430 push the pre-cleaned air out of the fan housings 421, 431 and into the surrounding atmosphere via the fan outlets 423, 424 and 433 and 434.

Having described the illustrated embodiment, it will become apparent that various modifications can be made without departing from the scope of the invention as defined in the accompanying claims. Further, the work vehicle on which the invention may be used is not limited to the exemplary work vehicle illustrated and described herein but may be applied to other vehicles such as, for example, skid steers.

1. A cooling system for a work vehicle operating in an atmosphere with high particulate content, the engine cooling system comprising:
at least one pre-cleaner having a pre-cleaner inlet and a pre-cleaner outlet, the at least one pre-cleaner receiving atmospheric air with a particulate content at the pre-cleaner inlet and releasing pre-cleaned air with a reduced particulate content at the pre-cleaner outlet;
at least one heat exchanger having a first side and a second side;
at least one fan; and
a chamber having a first chamber portion and a second chamber portion, the chamber enclosing the at least one heat exchanger, the at least one fan drawing the pre-cleaned air through the chamber from the first chamber portion through the second chamber portion and exhausting the pre-cleaned air to the atmosphere, the pre-cleaner outlet providing the pre-cleaned air at the first chamber portion, the at least one heat exchanger receiving the pre-cleaned air at the first side and allowing the pre-cleaned air to exit at the second side.

2. The cooling system of claim 1, wherein the pre-cleaner outlet is mounted to the first chamber portion.

3. The cooling system of claim 1, wherein the chamber comprises at least one inlet hole in the first chamber portion and at least one outlet hole in the second chamber portion.

4. The cooling system of claim 1, wherein the at least one fan comprises at least one backward curved centrifugal fan.

5. The cooling system of claim 4 wherein the at least one backward curved centrifugal fan comprises a fan frame with one inlet port and two outlet ports, the inlet port receiving the pre-cleaned air from the chamber, the two outlet ports exhausting the pre-cleaned air to the atmosphere.

6. An engine cooling system for an engine operating in an atmosphere with a high particulate content, the engine cooling system comprising:
at least one pre-cleaner having a pre-cleaner inlet and a pre-cleaner outlet, the at least one pre-cleaner receiving atmospheric air with a high particulate content at the pre-cleaner inlet and releasing pre-cleaned air with a low particulate content at the pre-cleaner outlet;
at least one heat exchanger having a first side and a second side;
at least one fan; and
a chamber having a first chamber portion and a second chamber portion, the chamber enclosing the at least one heat exchanger, the at least one fan drawing the pre-cleaned air through the chamber from the first chamber portion through the second chamber portion and exhausting the pre-cleaned air to the atmosphere, the pre-cleaner outlet providing the pre-cleaned air at the first chamber portion, the at least one heat exchanger receiving the pre-cleaned air at the first side and allowing the pre-cleaned air to exit at the second side.

7. The engine cooling system of claim 1, wherein the pre-cleaner outlet is mounted to the first chamber portion.

8. The engine cooling system of claim 1, wherein the chamber comprises at least one inlet hole in the first chamber portion and at least one outlet hole in the second chamber portion.

9. The engine cooling system of claim 1, wherein the at least one fan comprises at least one backward curved centrifugal fan.

10. The engine cooling system of claim 4 wherein the at least one backward curved centrifugal fan comprises a fan frame with one inlet port and two outlet ports, the inlet port receiving the pre-cleaned air from the chamber, the two outlet ports exhausting the pre-cleaned air to the atmosphere.

11. A method of cooling fluid for a work vehicle, the work vehicle having a cooling system including at least one pre-cleaner having a pre-cleaner inlet and a pre-cleaner outlet; at least one heat exchanger having a first side and a second side; at least one fan having an inlet and at least one outlet; and a chamber having a first chamber portion and a second chamber portion, the chamber enclosing the at least one heat exchanger, the chamber directly communicating only with the pre-cleaner outlet at the first chamber portion and the at least one fan inlet at the second chamber portion, the method comprising:
drawing atmospheric air with particulate content through the pre-cleaner from the pre-cleaner inlet through the pre-cleaner outlet with the at least one fan to obtain pre-cleaned air with a reduced particulate content;
flowing the pre-cleaned air across the heat exchanger with the at least one fan; and
drawing the pre-cleaned air from the chamber and exhausting it to the atmosphere with the at least one fan.
